(19) United States
(12) Patent Application Publication
(10) Pub. No.: US 2012/0089480 A1
(43) Pub. Date: Apr. 12, 2012

(54) ONLINE PURCHASING SYSTEM AND METHODS WITH BUYER'S AGENCY

(76) Inventor: Eugene A. Fusz, Palm Beach, FL (US)

(21) Appl. No.: 12/900,260

(22) Filed: Oct. 7, 2010

(51) Int. Cl. G06Q 30/00

(52) U.S. Cl. 705/26.41; 705/27.1

(57) ABSTRACT

A method of operating an online purchasing system for use by a plurality of buyers includes receiving product information from a client system including a buyer-observed price of a product that is input by one of the plurality of buyers, using a server system to execute a multi-input search algorithm and to determine a sales price for the product, wherein the sales price is a lowest price available from at least one online search tool and the buyer-observed price, and transmitting the sales price to a client system for display to one of the plurality of buyers.

### BACKGROUND

The embodiments described herein relate generally to purchasing products via an online consumer product purchasing system and, more particularly, to methods and systems for providing an online purchasing system that performs as a buyer's agent having fiduciary duties to the buyer.

When wishing to purchase a product, many consumers spend a great amount of otherwise valuable time traveling to various merchandisers and/or browsing the Internet in order to compare prices. At least some known systems enable a consumer to search the Internet for a particular manufacturer or model of a product, and to manually compare returned prices. Moreover, at least some known systems enable consumers to bid for a particular product online. However, such systems do not anticipate the constraints and/or motivations of buyers and sellers within the consumer product marketplace. For example, such systems do not consistently enable buyers to specify only a particular product and to receive prices for only that product. Rather, in general, known systems supply a buyer with a range of options that are related to the product the buyer specified. This forces the buyer to sift through the results to locate the particular product. This also makes it more difficult to compare prices for a particular product.

In addition, known systems generally deal with only a single buyer at a time. For example, such systems do not enable buyers to join forces in order to form a cooperative group that encourages sellers to enter an offer to sell in advance in order to be a low cost provider of a product. Rather, each buyer performs his own search for a desired product, searches for an acceptable price of the product, and determines the acceptability of the seller associated with the acceptable price. This lessens the power of each buyer to reduce prices for all buyers or for groups of buyers. A buyer's agent relationship enables groups of buyers to receive lower prices and better or more attentive service to facilitate large repetitive purchases by a buyer's agent from the vendor.

Moreover, such systems generally do not enable a buyer to enter an observed price such that the observed price is considered in determining a lowest price. Rather, the prices presented to the buyer are only those approved of by such systems or the prices already known to such systems. Furthermore, such known systems do not enable sellers to obtain instantaneous information related to the marketplace, and to use that information to purchase product more cost effectively from manufacturers.

### BRIEF DESCRIPTION

In one aspect, a method is provided for operating an online purchasing system for use by a plurality of buyers, wherein the purchasing system includes a server system and a memory area, and the server system is coupled to a client system via a communication network. The method includes receiving product information from the client system including a buyer-observed price of a product that is input by one of the plurality of buyers, executing, by the server system, a multi-input search algorithm and determining a sales price for the product, wherein the sales price is a lowest price available from at least one online search tool and the buyer-observed price, and transmitting the sales price to the client system for display to one of the plurality of buyers.

In another aspect, a buyer's agency system facilitates consumer product purchasing with fiduciary responsibilities undertaken by the system. The system includes a memory area configured to store product information for a plurality of products and a server system coupled to the memory area. The server system is also coupled to a plurality of client systems via a communications network, and is configured to receive product information from one of the plurality of client systems. The server system is also configured to execute a multi-input search algorithm and to determine a sales price for the product, wherein the sales price is a lowest price available from a plurality of online search tools, and wherein the lowest price is at least partially based on bulk purchasing by a plurality of buyers. Furthermore, the server system is configured to transmit the sales price to one of the plurality of client systems for display to one of the plurality of buyers without identifying a seller associated with the sales price.

In another aspect, a consumer product clearinghouse system includes a memory area configured to store product information including a unique product identifier for each of a plurality of products and a plurality of search strings for use with a plurality of online search tools. The system also includes a server system coupled to the memory area and to a client system via a communication network. The server system is configured to receive product information for a product from the client system, execute a search algorithm to determine a lowest price from each of the online search tools using the search strings, determine a sales price by comparing the lowest price from each of the online search tools, and transmit the sales price to the client system for display to a buyer.

### BRIEF DESCRIPTION OF THE DRAWINGS

FIG. 1 is a simplified block diagram of an exemplary system for use in an online purchasing system.

FIG. 2 is an expanded block diagram of an exemplary embodiment of a system architecture of the system shown in FIG. 1.

FIG. 3 is a flowchart illustrating a method of setting up the online purchasing system shown in FIG. 2.

FIG. 4 is a flowchart illustrating a method of operating the online exchange system shown in FIG. 2.

### DETAILED DESCRIPTION

Embodiments described herein provide a free online buying service for products, such as name-brand consumer products. Moreover, the embodiments described herein facilitate providing buyers with the lowest price available on the Internet. Typically, buying services make purchasing easier and more cost-effective. There are many types of buying services to consumers, from personal shoppers to corporate purchasing departments to farmers' co-ops. As a consumer buying service, the embodiments described herein represent consumers' best interests in the marketplace. For example, the embodiments described herein use a price search system to instantly identify the best price available and to ensure that buyers will receive the lowest price by enabling buyers to enter prices that are lower when found elsewhere. The search system provides consumers with prices they could not obtain on their own within a safe and secure transaction. Moreover, the embodiments described herein provide rewards such as additional discounts to consumers that discover and inform the system other previously unknown lower prices. To provide these advantages, the embodiments described herein use volume buying power to negotiate with sellers. The sellers submit offers to sell that are compared with the best price currently on the Internet. Furthermore, the embodiments described herein provide a secure buying environment, safe and timely delivery of purchased products, and a consumer-friendly return policy. A secure buying environment protects customer information, such as a credit card number, expiration data, mailing address, by encrypting the information between the buyer's computer and the system, and by simply forwarding the encrypted information to a secure payment provider rather than examining and/or storing the information at the system. Moreover, as new vendors or sellers are added to the system, the buyer's information is protected by using payment information that belong to the system to pay the sellers rather than the buyer's information. The system then receives payment from the buyer via the secure payment provider. Accordingly, the buyer's information is not displayed or viewed at any time during the transaction or by any party.

In some embodiments, the term “offer to sell” refers to an offer by a seller to sell a product at a specified price. Such an offer may be modified during, for example, a bidding process. Moreover, in some embodiments, the term “reserve price” refers generally to a minimum price at which a seller is willing to sell a product. As such, as used herein, the term “offer to sell” refers to an offered sales price by a seller for a particular product, and the term “reserve price” refers to an offer to sell that is expressed as a lowest acceptable offer to sell sales price.

In some embodiments, the term “online search tool” refers to an Internet website that enables a user to search for a specified term. More specifically, as used herein, the term “online search tool” refers to an Internet purchasing website. Exemplary purchasing websites include, but are not limited to, Overstock.com®, Amazon.com®, PriceGrabber.com®, QVC.com®, BizRate.com®, and any other suitable website that enables a user or system to search for a product and to determine a sales price for the product using an Internet search (Overstock.com is a registered trademark of Overstock.com, Inc., Salt Lake City, Utah, USA; Amazon.com is a registered trademark of Amazon.com, Inc., South Seattle, Wash., USA; PriceGrabber.com is a registered trademark of PriceGrabber.com, Inc., Los Angeles, Calif., USA; QVC.com is a registered trademark of ER Marks, Inc., Wilmington, Del., USA; and BizRate.com is a registered trademark of BizRate.com, Los Angeles, Calif., USA).

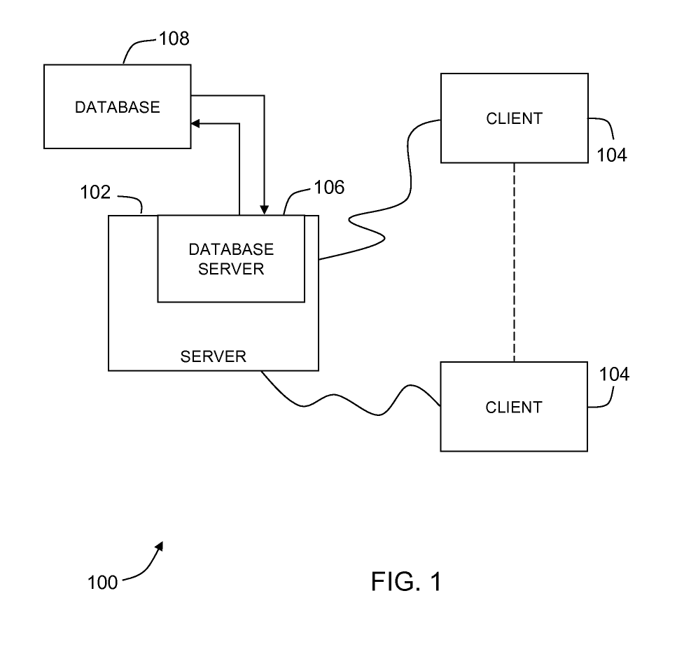

FIG. 1 is a simplified block diagram of an exemplary system 100 in accordance with one embodiment. In the exemplary embodiment, system 100 includes a server system 102, and a plurality of client sub-systems, also referred to as client systems 104, connected to server system 102. In one embodiment, client systems 104 are computers including a web browser and/or a client software application, such that server system 102 is accessible to client systems 104 over a network, such as the Internet and/or an intranet. Client systems 104 are interconnected to the Internet through many interfaces including a network, such as a local area network (LAN), a wide area network (WAN), dial-in-connections, cable modems, wireless modems, and/or special high-speed Integrated Services Digital Network (ISDN) lines. As described above, client systems 104 may be any device capable of interconnecting to the Internet including a computer, web-based phone, personal digital assistant (PDA), or other web-based connectable equipment. A memory area server 106 is connected to a memory area 108 containing information on a variety of matters, such as data related to facilitating an online buyer's agency system that facilitates bulk purchases from one or more sellers by ever-increasing numbers of buyers while ensuring that the buyers' identities and billing information are protected. In one embodiment, centralized memory area 108 is stored on server system 102 and is accessed by potential users at one of client systems 104 by logging onto server system 102 through one of client systems 104. In an alternative embodiment, memory area 108 is stored remotely from server system 102 and may be non-centralized.

As discussed below, memory area 108 may contain buyer profiles, seller profiles, product profiles, and/or system configuration information. A buyer profile may include, but is not limited to only including, a buyer identifier such as a user name, a password, contact information, mailing information, saved product searches, and/or user preferences for use in searching memory area 108 and/or displaying product searches via client system 104. A seller profile may include, for example, seller identifier such as a user name, a password, contact information, mailing and/or shipping information, billing and/or invoicing information, and/or offer information. In some embodiments, offer information includes only an offer to sell at a designated price as specified by a seller. In some other embodiments, offer information includes a reserve price designated by a seller.

The embodiments illustrated and described herein as well as embodiments not specifically described herein but within the scope of aspects of the invention constitute exemplary means for conducting an online purchasing system for use in dynamic bidding between anonymous sellers, and more particularly, constitute exemplary means for providing buyer's agency services to a plurality of buyers to leverage bulk purchases from the buyers into lower prices from one or more sellers. For example, server system 102 or client system 104, or any other similar computer device, programmed with computer-executable instructions illustrated in FIG. 1 constitutes exemplary means for conducting an online purchasing system for use in dynamic bidding between anonymous sellers.

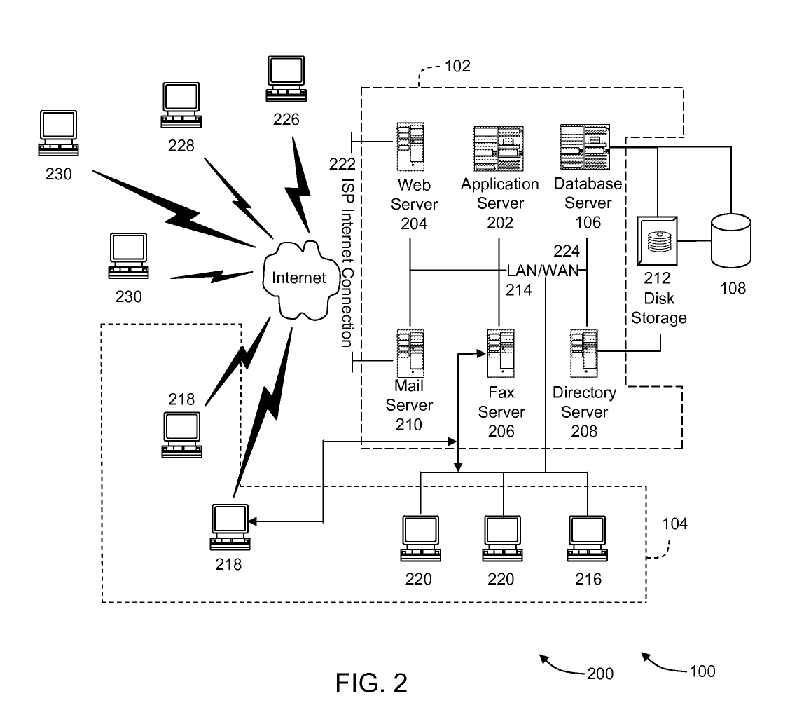

FIG. 2 is an expanded block diagram of an exemplary embodiment of a system architecture 200 of system 100 (shown in FIG. 1) in accordance with one embodiment. Components in system architecture 200, identical to components of system 100, are identified in FIG. 2 using the same reference numerals used in FIG. 1. System 200 includes server system 102 and client systems 104. Server system 102 further includes memory area server 106, an application server 202, a web server 204, a fax server 206, a directory server 208, and a mail server 210. A disk storage unit 212 is coupled to memory area server 106 and directory server 208. Examples of disk storage unit 212 include, but are not limited to including, a Network Attached Storage (NAS) device and a Storage Area Network (SAN) device. Memory area server 106 is also coupled to memory area 108. Servers 106, 202, 204, 206, 208, and 210 are coupled in a local area network (LAN) 214. Client systems 104 may include a system administrator workstation 216, a number of buyer workstations 218, and a number of seller workstations 220 coupled to LAN 214.

Each client system 104, including workstations 216, 218, and 220, is a personal computer having a web browser and/or a client application. Server system 102 is configured to be communicatively coupled to client systems 104 to enable server system 102 to be accessed using an Internet connection 222 provided by an Internet Service Provider (ISP). The communication in the exemplary embodiment is illustrated as being performed using the Internet, however, any suitable wide area network (WAN) type communication can be utilized in alternative embodiments, that is, the systems and processes are not limited to being practiced using the Internet. In addition, local area network 214 may be used in place of WAN 224. Further, fax server 206 may communicate with remotely located client systems 104 using a telephone link. Server system 102 is further coupled to one or more shipping provider systems 226, a secure payment provider system 228, and to a plurality of online search tools 230.

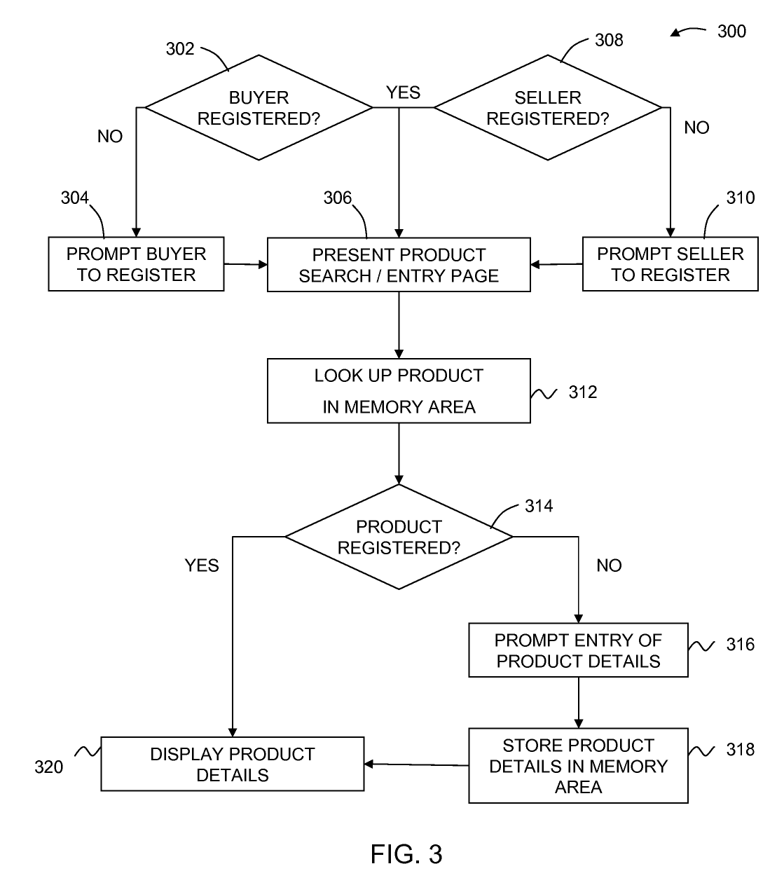

FIG. 3 is a flowchart 300 that illustrates a method of setting up an online purchasing system, such as system 200 (shown in FIG. 2) for facilitating dynamic, anonymous bidding by a plurality of sellers. In some embodiments, and when a buyer accesses system 200 using, for example, buyer workstation 218 (shown in FIG. 2), server system 102 (shown in FIGS. 1 and 2) determines 302 whether the buyer is registered with system 200. Upon a determination that the buyer is not registered with system 200, the buyer is prompted to register 304 with system 200. During registration, the buyer provides, for example, a name and contact information, such as an email address, a residential address, a work address, a phone number, and/or payment or banking information. The buyer may also provide a user identifier and a password. Alternatively, the buyer may provide a user identifier and password for a social media network, which enables the user to post new products and/or low prices observed using system 200. Upon receiving a determination that the buyer is registered with system 200 or, alternatively, upon registering 304 with system 200, server system 102 presents 306 the buyer with a product search tool that enables the buyer to search for a desired product using filterable fields including, but not limited to, manufacturer, model, color, etc. The server system 102 also enables the buyer to enter product information as described further below. Notably, buyers are not required to register with system 200 but, rather, may search for products, submit buyer-observed prices for products, and/or purchase products as described below without registering.

Similarly, in some embodiments, and when a seller accesses system 200 using, for example, seller workstation 220 (shown in FIG. 2), server system 102 determines 308 whether the seller is registered with system 200. Upon a determination that the seller is not registered with system 200, the seller is prompted to register 310 with system 200. During registration, the seller provides, for example, a name and contact information, such as an email address, web page URL, a business address, a phone number, a fax number, shipping information, and/or payment information. The seller may also provide a user identifier and a password. Upon receiving a determination that the seller is registered with system 200 or, alternatively, upon registering 310 with system 200, server system 102 presents 306 the seller with a product search tool that enables the seller to search for a product and/or create a product profile as described below. Notably, sellers are not required to register with system 200 but, rather, may search for products, submit offers to sell for products, and/or sell products as described below without registering. However, registration with system 200 by sellers may be advertised via, for example, seller workstation 200. For example, system 200 may display incentives to an unregistered seller via seller workstation 200, such as an offer to add a preselected amount of money to a sales price of a product or a time period when the seller would not be charged a service fee for sales made via system 200.

An administrator of system 200 or, alternatively, any buyer or seller that has registered with system 200 as described above may wish to create a new product profile for a particular product. As such, a buyer or seller enters 312 or looks up the product in a memory area, such as memory area 108 (shown in FIGS. 1 and 2), of system 200. In so doing, the buyer or seller enters resource data into system 200 to identify the product. Server system 102 compares the entered data to data already stored in memory area 108 to determine 314 whether the product was previously added to system 200. Examples of the product data include a manufacturer of the product, a model name or model number of the product, and/or a stock keeping unit number (SKU) of the product. If the product as described by the buyer or seller is not detected within system 200, the buyer or seller is prompted to enter 316 a full description of the product. Server system 102 may be configured to implement string matching such that if server system 102 detects that the entered product data does not exactly match product data already stored in memory area 108, server system 102 may be configured to prompt the buyer or seller to change an entered value. When the data relating to the new product is entered, server system 102 stores 318 the product information in memory area 108 and identifies the product using a product identifier. In one embodiment, product data may also be entered by an administrator of system 200 using, for example administration workstation 216. If the product has already been entered into system 200, the product information is displayed 320 to the buyer or seller. In an alternative embodiment, memory area 108 may include predetermined product information that is compiled by an outside source for use by system 200.

Moreover, server system 102 generates partial search strings for the product for use with online search tools 230 (shown in FIG. 2). For example, online search tools 230 use a substantially similar search string for any search that is executed. Accordingly, server system 102 saves into memory area 108 a portion of the search string associated with each online search tool 230, such that the saved portion includes a placeholder or variable that is replaced with product information when a search is to be performed by server system 102 using online search tools 230.

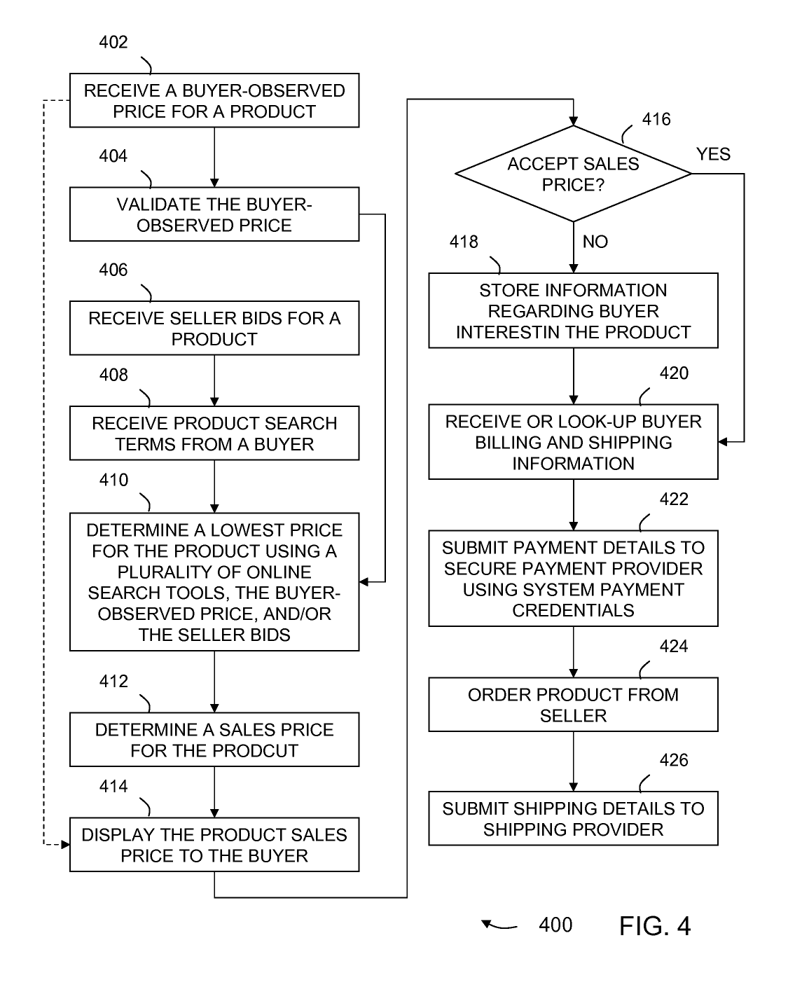

FIG. 4 is a flowchart 400 illustrating a method of operating an online purchasing system, such as system 200 (shown in FIG. 2) for facilitating dynamic, anonymous bidding by a plurality of sellers using a multi-input search algorithm that includes, for example, a metadata search, keyword search, or any suitable search methodology for use on the Internet. System 200 not only identifies the lowest price available on the Internet, but also enables a buyer to enter a lower price that has been observed by the buyer on the Internet and that may not have been found using the multi-input search algorithm. Moreover, system 200 provides buyers with price transparency, which results in a lowest possible price by displaying the online search tools 230 that were used to identify the lowest price on the Internet. Accordingly, system 200 provides an ever-changing list of prices and online search tools 230 that are used to identify product prices based on buyer-observed prices that are submitted to system 200. Furthermore, system 200 provides a guarantee to buyers that the buyers will receive the lowest possible price on the Internet. For example, system 200 acts as a buyer's agent for buyers and owes the buyers a fiduciary duty to act in the buyers' best interest. In the exemplary embodiment, system 200 receives 402 a buyer-observed price for a product. System 200 then validates 404 the buyer-observed price. For example, server system 102 (shown in FIGS. 1 and 2) receives the observed price and identifying information for the product, such as a model number, SKU, or any other identifying information. Server system 102 also receives a hyperlink or a URL for a website at which the buyer discovered the entered price. Server system 102 compares the entered price to the price offered at the entered URL to verify the entered price. For example, server system 102 may use character recognition software to determine the price offered at the entered URL. Alternatively, server system 102 may analyze the code, such as HTML, used to display the website at the entered URL to determine the price offered at the entered URL.

Sellers are also encouraged to actively participate in determining the lowest price for a product. In some embodiments, system 200 searches seller websites that are self-identified to system 200 by the sellers. However, the sellers can also enter a new, lower price as an offer to sell in order to obtain additional sales. For example, system 200 receives 406 an offer to sell from each seller that wishes to enter an offer for a particular product in the form of a reserve price for the product. In some embodiments, system 200 limits sellers from duplicating previously submitted reserve prices. In such an embodiment, when a seller submits a reserve price that has already been submitted, system 200 displays a notification to the seller using, for example, a web page, that informs the seller that the reserve price has already been submitted and requests that the seller submit a different reserve price. Moreover, in some embodiments, each seller is capable of displaying at seller workstation 218 (shown in FIG. 2) any previously entered offers to sell and/or a quantity of the product available. Each reserve price that is received by system 200 is stored in memory area 108 and associated with a product identifier.

In the exemplary embodiment, system 200 then receives 408 product search terms from a buyer using buyer workstation 218. For example, the buyer may navigate to a web page hosted by web server 204. After logging in, as described above, the buyer may use a number of filtering tools to find a desired product. Such tools may include drop down lists, radio-style buttons, text search fields, and other known search and/or filtering tools. In some embodiments, the buyer may start with a broad category, such as televisions, and use the filtering tools to narrow the results to, for example, a desired manufacturer. The buyer may then again use the filtering tools to narrow the results to, for example, a desired size, model, or the like. Once the buyer finds the desired product, the buyer displays the product information entered as described above.

In the exemplary embodiment, system 200 determines 410 a lowest price of the product available using online search tools 230 (shown in FIG. 2) as inputs into the multi-input search algorithm. In addition, system 200 determines 410 the lowest price of the product using a buyer-observed price, if any, and/or the received seller offers. Accordingly, system 200 enables buyer and/or sellers to dynamically observe prices for a product as the prices change due to new search results using the multi-input search algorithm, newly input buyer-observed prices, and/or newly input or modified seller offers. For example, server system 102 conducts a web-based search over the Internet using online search tools 230 in order to determine a lowest price available from each online search tool 230. Server system 102 determines a partial search string stored in memory area 108 that is associated with each online search tool 230, and inserts the entered product information into each partial search string to generate complete search strings for each online search tool 230. The complete search strings are transmitted to online search tools 230 using the Internet, for example, and server system 102 receives search results, including at least a lowest price for the product available from each online search tool 230, as well as a vendor associated with the lowest price. Server system 102 then stores the lowest prices and information related to the vendors in memory area 108 and associates the lowest prices with the product identifier and an identifier for the associated online search tool 230. Moreover, in some embodiments, the buyer may select which online search tools 230 are to be used in determining the sales prices. For example, the buyer may select the desired online search tools 230 using check boxes or radio buttons, such that only the selected online search tools 230 are queried for lowest prices for the product.

The lowest prices available from each online search tool 230 are then compared to each other in order to determine an overall lowest price for the product and the vendor associated with the overall lowest price. In some embodiments, the lowest price may be entered by a system administrator, a buyer, or a seller. Any prices entered for a product are then compared to previously entered prices and/or prices previously obtained via a search in order to determine the lowest price of the product. Moreover, in some embodiments, a minimum advertised price may be obtained from a manufacturer of the product and entered as the lowest price. Once the lowest price is determined, it is stored in memory area 108 and linked to the product ID. It should be noted that, in some embodiments, supplemental searches may be made over the Internet in order to update the lowest price of the product. If a lower price is found than is currently associated with the product in memory area 108, then the newly found lowest price may be stored in memory area 108 as the lowest price of the product.

After reserve prices and the lowest price associated with the product have been stored in memory area 108, system 200 determines 412 the sales price and stores the sales price in memory area 108 using the multi-input search algorithm. In the exemplary embodiment, server system 102 compares each reserve price associated with the product ID in memory area 108. Server system 102 also compares each reserve price to the lowest price that is associated with the product ID in memory area 108. After the comparisons between each reserve price and between each reserve price and the lowest price are completed, server system 102 determines the sales price. More specifically, each time a buyer displays the product information, server system 102 re-determines the sales price. For example, during a first visit to a web site hosted by server system 102, server system 102 determines a first sales price of the product and presents the buyer the first price of the product. During a subsequent second visit to the web site, server system 102 re-determines a second sales price of the product using the same steps used during the first visit, and presents the second sales price to the buyer. The first and second sales prices may be equal or may be different, based on the various offers to sell and/or reserve prices entered by sellers. For example, the sales price may drop between the first and second visits to the web site, and the second sales price will be accordingly lower. Alternatively, scarcity of the product between the first and second visits to the web site may cause the second sales price to be higher than the first sales price.

In an alternative embodiment, and when sellers submit offers for sale rather than reserve prices, server system 102 compares each offer associated with the product ID in memory area 108. Server system 102 also compares each offer to the lowest price that is associated with the product ID in memory area 108. After the comparisons are completed, server system 102 determines the sales price. In another alternative embodiment, and when each seller submits either an offer to sell or a reserve price, server system 102 compares each reserve price and each offer associated with the product ID in memory area 108. Server system 102 also compares each reserve price and each offer to the lowest price that is associated with the product ID in memory area 108. After the comparisons are completed, server system 102 determines the sales price.

Server system 102 then queries memory area 108 to obtain the sales price determined as described above. The product information and sales price are then displayed 414 to the buyer. In the exemplary embodiment, the identity of the seller is not displayed to the buyer. However, alternative embodiments may display the seller identity and/or contact information for the seller. Moreover, in one embodiment, the sales price of the product is not displayed but, rather, the buyer is prompted to request the sales price from system 200. In such an embodiment, the buyer may, for example, send an email to mail server 210, request a phone call from an administrator of system 200, or request an email from email server 210 in order to request the sales price. In the exemplary embodiment, the buyer may then enter 402 a buyer-observed price of the product via buyer workstation 218. For example, the buyer enters the buyer-observed price and a hyperlink, such as a URL, to a seller website or some other identifying information about the seller. In response to receiving the buyer-observed price, server system 102 validates 404 the entered price of the product to ensure the reliability of the entered price and to ensure that the entered price is lower than the product sales price. In some embodiments, when the buyer-observed price is lower than any of the lowest prices available via online search tools 230 and is lower than any reserve price or offer to sell from a seller, server system 102 reduces the buyer-observed price by a preselected amount or portion and transmits the reduced buyer-observed price to the buyer as the sales price.

After obtaining the sales price from server system 102, the buyer decides 416 whether to accept the sales price. If the buyer chooses not to purchase the product at the sales price, the buyer may then information related to the buyer's interest in the product, and system 200 stores 418 the entered information in memory area 108, for example. For example, the buyer may set a time to buy reminder that includes a time window, such as thirty days or ninety days, wherein server system 102 reminds the buyer at the end of the time window of the possible purchase. The buyer may then decide to purchase the product. Alternatively, the buyer may set a time to buy reminder that automatically purchases the product at the end of a time window. As another example, the buyer may set a price alert that includes a desired price such that server system 102 notifies the buyer that the sales price of the product has reached the buyer's desired price. The desired price may also be a range. For example, server system 102 may notify the buyer when the sales price of the product is between a first designated price and a second designated price. In addition, the buyer may use a combination of a time to buy reminder and a watch list. For example, the buyer may set up a watch list such that server system 102 notifies the buyer if the sales price of the product reaches a desired price or price range within a designated time window. Reminders and/or notifiers sent to the buyer may be in the form of an email, a phone call, a fax, a text message, an instant message, and/or any other suitable form of communication.

When the buyer accepts the sales price, the buyer then submits a purchase order to system 200, wherein the purchase order includes billing information and shipping information. In the exemplary embodiment, system 200 provides secure transmission and storage of the buyer's billing information, shipping information, and/or order history. The billing information may include, for example, a credit card number, expiration date, and/or security code. Moreover, in the exemplary embodiment, system 200 does not send the buyer's payment information to sellers. Rather, system 200 uses its own method of payment to purchase on the buyer's behalf and collects payment from the buyer via secure payment provider 228. For example, server system 102 transmits the billing information to secure payment provider 228 for storage. Notably, in the exemplary embodiment, server system 102 does not view or store the buyer's billing information and only completes a single encrypted transmission that includes the billing information to secure payment provider 228 as a means of protecting the buyer. Accordingly, in the exemplary embodiment, server system 102 receives 420 or looks up the stored billing and shipping information for the buyer. In some embodiments, if the buyer wishes to modify the billing information stored by secure payment provider 228, server system 102 forwards the updated billing information to secure payment provider 228, again without storing the billing information and using only a single encrypted transmission.

In the exemplary embodiment, system 200 submits 422 payment to the seller using billing information that is linked to a bank account or other account of system 200. System 200 is paid by secure payment provider 228 according to the buyer's stored billing information. Furthermore, the buyer is not provided with an identity of the seller or vendor, unless the buyer-observed price was used as the sales price. In some cases, the seller or vendor may not be registered with system 200. In such instances, system 200 submits payment to the seller or vendor for the product without identifying the buyer, and system 200 charges the buyer for the product via secure payment provider 228. Moreover, system 200 may offer the seller or vendor an incentive to register, such as a reduced transaction fee. In addition, system 200, such as server system 102, orders 424 the product from the seller having the winning offer to sell or from the vendor having the lowest price as determined via online search tools 230, as described above. System 200 may place the order electronically using, for example, a seller website or a vendor website, and using billing information that is linked to a bank account or other account of system 200. Alternatively, system 200 may place the order using, for example, email, a phone order placed by an administrator, a fax order placed by an administrator, or the like, again using billing information that is linked to a bank account or other account of system 200. However, when placing the order system 200 provides product information and a system transaction ID to the seller or vendor without providing billing information. In another embodiment, system 200 may conduct the transaction without providing any identifying information, such as identifying characteristics of the buyer, such as the buyer's name, billing information, or shipping information. Rather, system 200 instructs the shipper where to ship the product rather than the seller.

In the exemplary embodiment, system 200 leverages bulk buying for a plurality of buyers to enhance the timeliness of delivery, whereas single buyers are not able to negotiate or engage sellers or shippers in the same manner. For example, system 200 can remove seller offers, block new offers, or block access to system 200 to sellers that do not meet timeliness shipping metrics or responsiveness metrics. System 200 submits 426 the buyer's shipping information and the system transaction ID to shipping provider 226 without identifying the product or the buyer's billing information, as an additional means of buyer protection. In addition, in some embodiments, secure payment provider 228 submits payment for shipping and handling charges to system 200, and system 200 provides the payment to shipping provider 226. System 200 then receives payment from the buyer using the stored billing information. In the exemplary embodiment, system 200 facilitates safe and timely delivery of the purchased product to the buyer. For example, system 200 then monitors the shipping status on behalf of the buyer. For example, system 200 monitors the presence of a tracking number associated with the product. If system 200 does not detect a tracking number within a preselected time period, system 200 contacts shipping provider 226. System 200 may also then contact and arrange shipping with an alternative shipping provider 226. When system 200 detects a tracking number, it is sent to the buyer. Similarly, system 200 monitors the shipping status of the product to the buyer. If system 200 does not detect shipment within a preselected time period, system 200 contacts shipping provider 226. When system 200 detects that the product has shipped, system 200 monitors the estimated delivery date. System 200 also alerts the buyer in case of delivery delays after the product has been shipped.

In the exemplary embodiment, system 200 leverages bulk buying for a plurality of buyers to enhance the service quality both before and after purchases, whereas single buyers are not able to engage sellers in the same manner. For example, system 200 can remove seller offers, block new offers, or block access to system 200 to sellers that do not meet responsiveness metrics with regard to buyer questions about the product, order changes, product returns, and the like. In the exemplary embodiment, system provides a buyer-friendly return policy. For example, if the product arrives damaged at the buyer, the buyer may return the product to system 200. Alternatively, the buyer may return the product to the seller. Similarly, during a warranty period, the buyer may coordinate a return or repair of the product with system 200, or may coordinate directly with the seller.

Moreover, in some embodiments, when the seller sells an entire quantity of the product that has been stocked, system 200 re-determines 408 the sales price as described above. As such, although a particular seller may not enter a winning offer to sell during an initial evaluation and determination of the sales price, the seller's offer may be determined to be the winning offer at a later time.

Furthermore, in some embodiments, each seller may change a offer previously entered into system 200. For example, a seller may modify a respective offer in order to reduce an offer to sell or a reserve price that was entered by the seller. Server system 102 will automatically re-determine 408 the sales price using the reduced offer to sell or reserve price. Alternatively, in some embodiments, a seller may enable server system 102 to automatically reduce an offer to sell that was previously entered by the seller. Server system 102 will automatically re-determine the sales price using the reduced offer to sell.

Exemplary embodiments of systems and methods for providing an online consumer product clearinghouse as a buyer's agent with fiduciary duties to the buyer are described above in detail. The systems and methods are not limited to the specific embodiments described herein but, rather, operations of the methods and/or components of the system and/or apparatus may be utilized independently and separately from other operations and/or components described herein. Further, the described operations and/or components may also be defined in, or used in combination with, other systems, methods, and/or apparatus, and are not limited to practice with only the systems, methods, and storage media as described herein.

A controller, computing device, or computer, such as described herein, includes at least one or more processors or processing units and a system memory. The controller typically also includes at least some form of computer readable media. By way of example and not limitation, computer readable media may include computer storage media and communication media. Computer storage media may include volatile and nonvolatile, removable and non-removable media implemented in any method or technology that enables storage of information, such as computer readable instructions, data structures, program modules, or other data. Communication media typically embody computer readable instructions, data structures, program modules, or other data in a modulated data signal such as a carrier wave or other transport mechanism and include any information delivery media. Those skilled in the art should be familiar with the modulated data signal, which has one or more of its characteristics set or changed in such a manner as to encode information in the signal. Combinations of any of the above are also included within the scope of computer readable media.

Although described in connection with an exemplary online purchasing, or consumer purchasing, environment, embodiments of the invention are operational with numerous other general purpose or special purpose computing system environments or configurations. The online purchasing environment is not intended to suggest any limitation as to the scope of use or functionality of any aspect of the invention. Moreover, the online purchasing environment should not be interpreted as having any dependency or requirement relating to any one or combination of components illustrated in the exemplary operating environment. Examples of well known online purchasing environments and/or configurations that may be suitable for use with aspects of the invention include, but are not limited to, personal computers, server computers, hand-held or laptop devices, multiprocessor systems, microprocessor-based systems, set top boxes, programmable consumer electronics, mobile telephones, network PCs, minicomputers, mainframe computers, distributed computing environments that include any of the above systems or devices, and the like.

Embodiments of the invention may be described in the general context of computer-executable instructions, such as program modules, executed by one or more controllers, computers, or other devices. Aspects of the invention may be implemented with any number and organization of components or modules. For example, aspects of the invention are not limited to the specific computer-executable instructions or the specific components or modules illustrated in the figures and described herein. Alternative embodiments of the invention may include different computer-executable instructions or components having more or less functionality than illustrated and described herein.

The order of execution or performance of the operations in the embodiments of the invention illustrated and described herein is not essential, unless otherwise specified. That is, the operations may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

In some embodiments, the term “processor” refers generally to any programmable system including systems and microcontrollers, reduced instruction set circuits (RISC), application specific integrated circuits (ASIC), programmable logic circuits (PLC), and any other circuit or processor capable of executing the functions described herein. The above examples are exemplary only, and thus are not intended to limit in any way the definition and/or meaning of the term “processor.”

In some embodiments, the term “memory area” refers generally to any physical computer storage medium that is used to store data. Exemplary computer storage media include, but are not limited to only including, hard disk drives, random access memory (RAM), read-only memory (ROM), flash drives, CD ROM, DVD ROM, and the like. Moreover, a memory area may be located within a computer, may be externally coupled to a computer, or may be a removable medium. Furthermore, a memory area may be embodied as a database that includes any collection of data including hierarchical databases, relational databases, flat file databases, object-relational databases, object oriented databases, and any other structured collection of records or data that is stored in a computer system. The above examples are exemplary only, and thus are not intended to limit in any way the definition and/or meaning of the term “memory area” or the term “database.” Examples of databases include, but are not limited to only including, Oracle® Database, MySQL, IBM® DB2, Microsoft® SQL Server, Sybase®, and PostgreSQL. However, any database may be used that enables the systems and methods described herein. (Oracle is a registered trademark of Oracle Corporation, Redwood Shores, Calif.; IBM is a registered trademark of International Business Machines Corporation, Armonk, N.Y.; Microsoft is a registered trademark of Microsoft Corporation, Redmond, Wash.; and Sybase is a registered trademark of Sybase, Dublin, Calif.)

When introducing elements of aspects of the invention or embodiments thereof, the articles “a,” “an,” “the,” and “said” are intended to mean that there are one or more of the elements. The terms “comprising,” including,” and “having” are intended to be inclusive and mean that there may be additional elements other than the listed elements.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A method of operating an online purchasing system for use by a plurality of buyers, the purchasing system including a server system and a memory area, the server system coupled to a client system via a communication network, the method comprising:
receiving product information from the client system including a buyer-observed price of a product that is input by one of the plurality of buyers;
executing, by the server system, a multi-input search algorithm and determining a sales price for the product, wherein the sales price is a lowest price available from at least one online search tool and the buyer-observed price; and
transmitting the sales price to the client system for display to one of the plurality of buyers.

2. A method in accordance with claim 1, wherein executing a multi-input search algorithm comprises repeatedly performing a search over the communication network using a plurality of online search tools to obtain a lowest price for the product from each of the online search tools.

3. A method in accordance with claim 2, wherein performing a search using a plurality of online search tools comprises:
inserting the product information into respective partial search strings associated with the online search tools to create respective complete search strings for use by the online search tools;
transmitting each completed search string to an associated online search tool of the plurality of online search tools; and
receiving the respective lowest prices for the product from the online search tools.

4. A method in accordance with claim 1, wherein, when the buyer-observed price is lower than the lowest price available from the at least one online search tool, said transmitting the sales price comprises:
reducing the buyer-observed lowest price by a preselected amount; and
transmitting the reduced buyer-observed lowest price to the client system for display to the buyer as the sales price.

5. A method in accordance with claim 1, further comprising receiving a purchase order for the product from the client system, wherein the purchase order includes billing information and shipping information.

6. A method in accordance with claim 5, further comprising transmitting a product identifier and a system transaction identifier to a seller associated with the sales price by the at least one online search tool such that the buyer is not identified to the seller.

7. A method in accordance with claim 5, further comprising transmitting the billing information to a secure payment provider for use in submitting payment to a seller associated with the sales price by the at least one online search tool.

8. A method in accordance with claim 5, further comprising transmitting the shipping information and a system transaction identifier to a shipping provider such that the product is not identified to the shipping provider.

9. A method in accordance with claim 8, further comprising tracking shipment of the product to the buyer via the communication network.

10. A buyer's agency system for facilitating consumer product purchasing, said buyer's agency system comprising:
a memory area configured to store product information for a plurality of products; and
a server system coupled to said memory area, said server system further coupled to a plurality of client systems via a communications network, said server system configured to:
receive product information from one of the plurality of client systems;
execute a multi-input search algorithm and to determine a sales price for the product, wherein the sales price is a lowest price available from a plurality of online search tools, and wherein the lowest price is at least partially based on bulk purchasing by a plurality of buyers; and
transmit the sales price to one of the plurality of client systems for display to one of the plurality of buyers without identifying a seller associated with the sales price.

11. A buyer's agency system in accordance with claim 10, wherein said server system is further configured to perform a search over the communication network using the plurality of online search tools to obtain respective lowest prices for the product from the online search tools.

12. A buyer's agency system in accordance with claim 11, wherein said server system is further configured to:
insert the product information into respective partial search strings associated with the online search tools and stored in said memory area to create respective complete search strings for use by the online search tools;
transmit each completed search string to an associated online search tool of the plurality of online search tools; and
receive the respective lowest prices for the product from the online search tools.

13. A buyer's agency system in accordance with claim 10, wherein said server system is further configured to:
receive a buyer-observed price of the product from the server system;
determine the sales price by comparing the lowest price available from each of the plurality of online search tools and the buyer-observed price
when the buyer-observed price is lower than the lowest price available from the plurality of online search tools, reduce the buyer-observed lowest price by a preselected amount; and
transmit the reduced buyer-observed lowest price to the client system for display to the buyer as the sales price.

14. A buyer's agency in accordance with claim 10, wherein said server system is further configured to transmit billing information of the buyer to a secure payment provider in an initial occurrence such that the secure payment provider stores the billing information for future transactions.

15. A buyer's agency system in accordance with claim 10, wherein said server system is further configured to:
receive a purchase order for the product from the client system, wherein the purchase order includes billing information and shipping information;
transmit a product identifier and a system transaction identifier to a seller associated with the sales price such that the buyer is not identified to the seller; and
transmit the shipping information and a system transaction identifier to a shipping provider such that the product is not identified to the shipping provider.

16. A consumer product clearinghouse system comprising:
a memory area configured to store product information including a unique product identifier for each of a plurality of products and a plurality of search strings for use with a plurality of online search tools; and
a server system coupled to said memory area, said server system further coupled to a client system via a communication network, said server system configured to:
receive product information for a product from the client system;
execute a search algorithm to determine a lowest price from each of the online search tools using the search strings;
determine a sales price by comparing the lowest price from each of the online search tools; and
transmit the sales price to the client system for display to a buyer.

17. A consumer product clearinghouse system in accordance with claim 16, wherein said server system is further configured to:
receive a buyer-observed price of the product from the server system; and
determine the sales price by comparing the lowest price from each of the online search tools and the buyer-observed price.

18. A consumer product clearinghouse system in accordance with claim 17, wherein, when the buyer-observed price is lower than the lowest price from each of the online search tools, said server system is further configured to:
reduce the buyer-observed lowest price by a preselected amount; and
transmit the reduced buyer-observed lowest price to the client system for display to the buyer as the sales price.

19. A consumer product clearinghouse system in accordance with claim 16, wherein said server system is further configured to:
insert the product information into each of the plurality of search strings associated with the plurality of online search tools to create a plurality of complete search strings for use by the online search tools;
transmit each completed search string to an associated online search tool of the plurality of online search tools; and
receive the respective lowest prices for the product from the online search tools.

20. A consumer product clearinghouse system in accordance with claim 16, wherein said server system is further configured to:
receive a purchase order for the product from the client system, wherein the purchase order includes billing information and shipping information;
transmit a product identifier and a system transaction identifier to a seller associated with the sales price;
transmit the billing information to a secure payment provider for use in submitting payment to the seller; and
transmit the shipping information and a system transaction identifier to a shipping provider.
